(19) United States
(12) Patent Application Publication
(10) Pub. No.: US 2022/0099253 A1
(43) Pub. Date: Mar. 31, 2022

(54) GAS STORAGE SYSTEM

(71) Applicant: SLLP 134 LIMITED, Aberdeen Aberdeenshire (GB)

(72) Inventor: Malcolm Bowie, Aberdeen Aberdeenshire (GB)

(21) Appl. No.: 17/426,783

(22) PCT Filed: Feb. 5, 2020
(86) PCT No.: PCT/EP2020/052914

§ 371 Date: Jul. 29, 2021

(30) Foreign Application Priority Data
Feb. 6, 2019 (GB) 1901658.3

(51) Int. Cl. F17C 13/08; F17C 1/00

(52) U.S. Cl. CPC F17C 13/082; F17C 1/007; F17C 2201/0138; F17C 2201/054; F17C 2203/0607; F17C 2270/0128; F17C 2203/0663; F17C 2205/0184; F17C 2221/012; F17C 2221/013; F17C 2223/0123; F17C 2203/0639

(57) ABSTRACT

A portable subsea storage tank for the storage of gas products under pressure or oil products consisting of pipeline sections in an array which can be coated in specialist coatings and recovered for inspection and re-use. A method of self-installing the subsea storage tank is also described.

The present invention relates to the storage of fluids, principally the storage of gas products under pressure, oil products which result from the exploration of oil and gas fields or from the production of hydrogen gas.

The storage of gases represents a significant challenge, due to the relatively low density of the gases at atmospheric temperatures and pressures and hence the very large storage volumes required often become impractical.

The solutions are generally to either pressurise the gas to reduce its volume or lower its temperature sufficient to reach either a supercritical or liquid phase, which results in the gas taking up much smaller volumes, to the order of hundredths of the gaseous phase. The use of both lower temperatures and high pressures can be used in combination to achieve the same objective.

The lower temperatures require energy and insulation to maintain the contents at the target temperature which is usually significantly lower than ambient temperature and in the case of hydrogen impractically low temperatures of less than −200° C. Thus temperature based storage may be termed ‘active storage’ since active management of the conditions is vital, together with careful selection of the material due to the cryogenic temperatures involved.

High pressures require high structural strength of the storage system to resist the stresses but have the advantage of being ‘passive storage’ with minimal management of the conditions being required.

Both storage methods can take up significant volumes on a fixed or floating structure. Pressurisation of stored gas will decrease the storage volume needed but requires heavy wall pipes or cylindrical tanks to withstand the stresses. The volumetric efficiency of cylinders increases with increasing diameter; however, the wall thickness requirement to accommodate the pressure increases rapidly and becomes impractical to fabricate and weld.

Spheres offer a more efficient containment due to the low surface area to volume ratio; however, they are more difficult to fabricate, and limited in individual capacity (unlike pipe joints which can be welded together).

The challenge for the offshore energy industry is to provide a practical and safe means to allow storage of gas, principally methane or hydrogen, for future use offshore or transportation to shore where the laying of an offshore pipeline is deemed uneconomic or impractical. The storage of hydrogen faces similar challenges especially if used as an energy storage system offshore, capturing any excess energy from wind farms during low demand period as hydrogen and releasing during high demand/low wind farm generation periods. Such hydrogen storage can also act in support of oil & gas production or carbon capture and storage, to minimise the emissions and smooth out the power supply from renewable energy generation.

In addition there is a potential emerging market for CNG transport (Compressed Natural Gas) with a number of vessels potentially arriving on the market to transport such products. Previously most gas transportation has been with cryogenically cooled gases such as LPG and LNG at a temperature of circa −160° C.

The storage of such gases on a floating structure has significant safety implications due to the flammability and pressure which equates to a large stored kinetic energy, plus the cost of a moored vessel can be very high. For temporary or lower cost base applications, a floating vessel may be either impractical or too expensive.

Pipelines may also be considered. These are normally laid from a pipelay barge or ship, in which the pipe joints are welded on-board before the ship moves forward to gradually lay the pipe on the seabed. To maximise the laying rate, new joints of pipe are welded at between 3 and 5 “welding stations” on-board the vessel to build-up the weld material in the joint to be equal to that of the parent pipe. If there are 5 passes/welding stations this means that the pipe is being moved and welded five times thus it is still being welded circa 60 m from the free end (assuming 12.2 m long joints).

This welding and the heat generated means it is very difficult to internally coat the pipeline to protect it from aggressive internal corrosion which can result from certain fluid compositions. Therefore certain corrosive fluids accept a corrosion and thinning of the wall by design, which is inefficient from a structural and material quantity perspective.

An alternative method to allow full internal coating is to weld the pipe joints together onshore and coat the inside of the pipeline when cooled. The advantage of this arrangement is that the cooling and internal coating, curing and inspection of the pipeline coating is not being performed during vessel time, which would be prohibitively expensive. However, the length of the pipe sections is limited by the space available (typically 1-4 km) and the sections of pipe need to be reeled onto a large diameter drum on the pipelay vessel.

The laying of the pipe offshore, in particular when reeled, introduces high strains in the pipe through the bending of the pipe on the reel or the ‘stinger’ which controls its curvature off the vessel. This can create cracking or disbanding of the internal and external coatings with other integrity problems and hence may preclude the use of more exotic coatings offshore.

A further disadvantage in using pipelines for storing fluids is that long lengths of pipeline cannot easily be recovered and relocated, since below a certain diameter they are buried and/or have concrete weight coat to provide ballast. Therefore the majority of rigid steel pipeline are categorised as “single use” since to re-lay for re-use at a different location is technically difficult to perform and demonstrate the re-used pipeline is fit-for-purpose.

The other option is to use a large subsea storage tanks; however, the size of most tanks is such that the gas can only be stored at a very low pressure to avoid high stresses in the tank wall and hence such arrangements are impractical.

Embedded within most of the options for offshore gas storage under pressure is the practicalities of transportation, installation and re-use of the storage arrangement for which there are limited practical or economic options currently available.

JPS54128817A illustrates a plurality of separate tanks for storing petroleum on the seabed. The tanks are filled with liquid petroleum at surface and then a ballast capacity on each tank is used to sink the tanks to the seabed where pairs of tanks are arranged in a frame. After a time, sand is packed around the tanks. The purpose of this is to stockpile oil and as the tanks are filled at the location, they are unlikely to be storing liquids under pressure, so the wall thickness of the tanks is expected to be low. The tanks are also not intended to be re-floated, towed or re-used in other locations and are therefore not portable.

Similar arrangements have been proposed in the form of a concrete subsea storage tank (CSST). A major disadvantage of such a material is in the structural efficiency of concrete under pressure with its inherent permeability.

There are equally methods of access to subsea tanks such as WO2016030670A2 which illustrates a method of accessing the top of a concrete storage tank. This method relates to a form of intervention not foreseen in the design of the concrete cylinders, which themselves are an integral part of a surface piercing oil platform jacket. The cylindrical tanks are principally designed to store oil and rest deep into the seabed due to their self-weight. The concrete tanks are only pressurised insofar to maintain the structural integrity against the hydrostatic pressure. The removal of such platforms presents enormous technical and environmental challenges and thus not considered to be portable or re-useable.

It is an object of the present invention to provide a subsea storage tank for the storage of gas products under pressure or oil products which obviates or mitigates at least some of the disadvantages of the prior art.

It is a further object of the present invention to provide a method of self-installing a subsea storage tank which obviates or mitigates at least some of the disadvantages of the prior art.

According to a first aspect of the present invention there is provided a portable subsea storage tank for the storage of gas products under pressure or oil products comprising: an array of pipe members, the pipe members connected together and configured to contain a fluid for storage;

a framework to hold the pipe members in the array;
a hull supporting the framework and providing transportation of the storage tank to and from a quayside to a location on the seabed and subsequent re-use at different locations;
ballast capacity to control the descent/ascent of the storage tank; and
an anchoring arrangement to hold the storage tank in position to the seabed.

By storing the fluid, being a liquid and/or gas, under the water on the seabed, a number of advantages are realised including; a stable temperature, usually a lower temperature than the surface and protected from the heat of the sun; not being constrained by ship deck area or load and intrinsically safe with no ignition sources; and the ballast can assist in stabilising the tank when positioned on the seabed. In addition the use of the surrounding water can aid in the thermal management of the fluids during internal pressurise variations, as compressing gas can lead to a temperature increase and any reduction in gas pressure can result in cooling through the Joule-Thomson effect. Further by being static on the seabed the fatigue loads in the pipe members are reduced significantly compared to a floating structure. The safety of the arrangement against the large kinetic energy of any rupture is enhanced by the external pressure and damping effect of water.

In making the tank portable, the tank can be re-floated, brought ashore for inspection/re-configuration as required and re-deployed at another location. Preferably, it combines the storage arrangement with a certified submersible tank or barge arrangement such that it complies with IMO, flag state and warranty/insurances requirements for transport, but yet is a structure which can equally rest on the seabed.

The tank may be configured in operation to allow offloading of CNG to a transportation vessel which utilises technologies such as the VOTRANS™, in which the gas during offloading is maintained under pressure by an exchange of gas with fluids, such as ethylene glycol. In this application the splitting of the storage capacity into a number of different pipe members or sections will allow flexibility in the offloading process.

Preferably the pipe members are formed from a plurality of pipe sections. In this way, standard pipe sections can be used. Preferably the pipe sections are heavy walled pipe sections, being of sufficient weight to sink in sea water when empty. In this way, pressurised gas can be safely stored while the additional weight of the steel, from which the pipe sections are made, provides the necessary ballast to keep the structure submerged when empty. Long lengths of pipe sections offer an efficient method of storage of gases and can advantageously use much of the existing methods and technology already employed in the offshore industries.

Preferably, the pipe members and/or pipe sections are connected by at least one pipe bend of minimum 60°. In this way, quarter zo turns and u-turns are provided to reduce the overall length of the pipe array while providing a large length of pipe for maximum storage volume. More preferably, the plurality of pipe sections are connected together as a continuous long section comprising of multiple turns to form a total length of at least double that of a length of the storage tank. A continuous length of pipe allows the use of standard pipe inspection techniques to be used such as pigging on one continuous operation rather than being performed on multiple sections. It also reduces the amount of separate valves and controls. Preferably, the plurality of pipe sections are connected one to another with a conduit, the conduit having a smaller diameter than the pipe sections. By use of a hose or narrower pipework, connections at bends can be made more easily.

Preferably, the framework includes connection means for installation of a pig launcher at a first location on the array and a pig receiver at a second location on the array to allow pipeline inspection, cleaning and flushing activities to be performed. When the pipe sections and pipe members form a continuous length of pipe, the pig launcher can be arranged at a first end of the pipe and the pig receiver can be at the other end of the pipe.

Preferably, the portable subsea storage tank includes a pipework manifold comprising a plurality of valves to control the distribution of the fluid through the array. Preferably, the valves are arranged to control the flow of fluid between each pipe member. The valves can be electronically controlled. Accordingly, one or more dynamic risers may be attached to the storage tank to allow the passage of fluids. Additionally an umbilical may be provided for command and control to mechanical and electrical systems on the framework.

Preferably the pipe sections are made of steel. More preferably, the pipe sections have an outside diameter between 0.50 m to 1.25 m. More preferably the pipe sections have an outside diameter between 30″ to 40″ (0.762 m to 1.016 m). Typically for internal pressures in the region of 150-250 barg, pipes with outside diameters in the region of 30″ to 40″ have wall thickness's and steel grades which are commonly available. Thus diameters in the region of commonly used large offshore pipelines, typical 24″ to 48″, become a practical limitation as wall thicknesses significantly greater than 1″ are no longer stock items.

The strength or grade of the steel must also be considered since hydrogen embrittlement of high tensile steels due to hydrogen, limits the physical strength of steel pipes used for such an application. Given the drive to a hydrogen economy it is vital that a solution is found to managing the hydrogen embrittlement issue but also maximise the use of subsea storage which dampens down the thermal variations due to compression and expansion.

Preferably the pipe members are 30 m to 150 m in length but equally can be connected to form a long continuous pipe section. In this way, the array can have a length between 30 m and many kilometres long of parallel arranged pipe members. The array may be two dimensional, but more preferably, the array is three dimensional. Pipes offer a well proven and simple to build option with the key advantage that the fabrication into long stalks, as pipe members, up to and well in excess of 100 m can be performed onshore at low cost.

Preferably the pipe members may have internal storage cylinders of high strength materials such as carbon fibre to contain the gas. The advantage of this arrangement is that the pipe members provide physical protection and ballast weight to counteract the buoyancy, but can be of a smaller wall thickness or strength than if the pipe member alone stored the gas. The pipe members can be protected against full pressure within the internal storage cylinder by provision of a pressure failure valve on the pipe member. Any leakage of gas from the internal storage cylinder will thus be managed and contained by the pipe members up to a pre-set pressure, by monitoring and controlled venting, or moving to another cylinder to prevent release.

Preferably the pipe sections are internally coated. Preferably also the pipe sections are welded together to form the pipe members. The pipes are of such a diameter that they can easily be internally coated, including the welded joint and inspected, especially if arranged as a long continuous section, where standard pigging techniques can be employed. The pipe internal coating integrity is advantageous to protect against the risks of internal and external corrosion. By not bending the pipe sections as is performed in normal offshore installation of pipelines, the use of more exotic and specialised coatings is possible, since the pipe sections do not undergo large strain cycles during installation.

The pipe members and framework may be arranged on a submersible barge. Alternatively the pipe members and framework with ballast capacity provides a floating structure.

The pipe members may be connected together such that each pipe member is independent and additional pipework brings an end of each pipe member together to provide an access point to the tank. Alternatively the pipe members may be connected together so that each pipe member is connected to a plurality of other pipe members via additional pipework. The pipe members may be connected together by additional pipework to form a continuous pipeline length. Preferably the additional pipework provides bends to connect respective ends of pipe members at each end of the framework. The bends are preferably sized to allow ‘pigging’ of the tank at intervals to condition, inspect and as required, clean the internals.

The pipe members may be arranged parallel to the seabed in the framework. In this way they are horizontally arranged. Preferably, the pipe members are arranged at an angle to the seabed. In this way, they provide a high-point and a low-point to allow gas to vent fully and liquids to drain fully. The pipe members may be arranged orthogonal to the seabed. In this way they are vertically arranged.

Preferably the pipe members are arranged and connected together such that there is a low-point and a high-point to allow gas to vent fully and liquids to drain fully. More preferably a vent is arranged at the high point and a drain is arranged at the low point.

The tank may include a manifold. The tank may include one or more static flowline connections. The tank may include a dynamic riser. The tank may include one or more sub-sea isolation valves. The tank may contain storage for other liquids or gases which are used in support of the offshore operations. In this way, the tank may act as a host for other subsea operations etc.

The tank may include a vertically extending portion arranged above the pipe members to be above sea level on deployment. Preferably the vertically extending portion includes a warning system. In this way the position of the tank can be visible to other sea users. The vertically extending portion may include additional storage for equipment to aid in management of and the loading and unloading the liquids in the storage tank.

The tank may form part of a permanent offshore jacket structure and be either installed together with the jacket or retrofitted to the jacket structure.

The anchoring means may be selected from a group comprising: suction anchors, driven piles, drilled piles, ballast weight and mooring lines.

According to a second aspect of the present invention there is provided a method of self-installing a portable subsea storage tank comprising the steps of:
(a) providing a portable subsea storage tank according to the first aspect;
(b) floating and towing the portable subsea storage tank to a desired location;
(c) adjusting ballast capacity on the subsea storage tank to thereby submerge the subsea storage tank;
(d) anchor the subsea storage tank to the seabed; and
(e) introducing a fluid into the pipe members of the subsea storage tank to store the fluid.

In this way, the storage tank is easily constructed and transportable for deployment and recovery for inspection and re-use.

Preferably the fluid is a gas stored under pressure. The pressure is dictated by the types of gas and a compromise between the storage volume achievable versus the economics. Alternatively or additionally the fluid may be hydrocarbons such as produced oil. The tank may contain a mixture of both liquids and gases in the same pipe member.

Preferably, when anchored the subsea storage tank may be located on the seabed. Alternatively, the subsea storage tank may be partially under the seabed or fully under the seabed level.

The use of lower temperature methods requires constant energy use to prevents the contents heating up excessively and given the high heat capacity of water this represents additional challenges for the insulation to maintain energy efficiency. The use of underground storage potentially reduces this risk as the surrounding static earth can be cooled generating a negative thermal gradient reducing the cooling requirements.

Preferably the tank is positioned at a desired depth by use of a mooring system as described in WO2017168144, the contents of which are incorporated herein by reference. WO2017168144 provides a method for installing a subsea structure at a target installation site in an underwater location. The method includes connecting at least one mooring line and at least one leading line to the structure, and towing the structure via the leading line from a deployment position to the target installation site, such that the structure moves both vertically and horizontally between the deployment position and the target installation site. The mooring line is anchored, e.g. to an anchoring device on the seabed, and can incorporate a ballast to apply a sinking force to the structure in proportion to the length of unsupported line. The mooring line and the leading line can together stabilise the structure as it descends the installation site. The non-vertical installation allows accurate structure placement, e.g. in crowded fields, with less sensitivity to tidal or current forces.

Preferably the method includes the step of adjusting the ballast to re-float the storage tank and towing the storage tank to a further location. In this way, reverse methodology is used to recover the tank.

Preferably, where a vertically extending section of the tank is present the method includes the step of using this fixed section to assist the control of installation through the water-plane area effect.

The method may include the step of lowering pipe members of the tank into a ‘glory hole’, being a depression into the seabed, so that minimal or no parts of the structure stick above mean seabed level.

Alternatively, the method may include the step of lowering the pipe members vertically into a pre-drilled hole in the seabed. This has the advantage that the storage is below seabed level and uses well-established drilling techniques to drill a hole of sufficient diameter to accommodate the pipe members. Whilst the pipe members would typically be of a length that can be tilted and lowered offshore into the hole, the length of the pipe members can be significantly longer if a pipeline connection system is used to connect multiple pipe sections together. The pipe members may be recoverable at the end of the field life or for replacement.

Preferably, method includes the step of inspecting the pipe members by using a pipeline pig. More preferably, the pipeline members may be internally coated, cured, inspected and repaired, if required, on-shore.

The gas being stored may be hydrogen under pressure produced from renewable sources. Alternatively, the gas being stored may be carbon dioxide under pressure prior to injection into sub-surface reservoirs. In this way, the portable subsea storage tank can be used both to store fluids and to output those fluids for use at the subsea location.

Embodiments of the present invention will now be described, by way of example only, with reference to the accompanying Figures, of which:

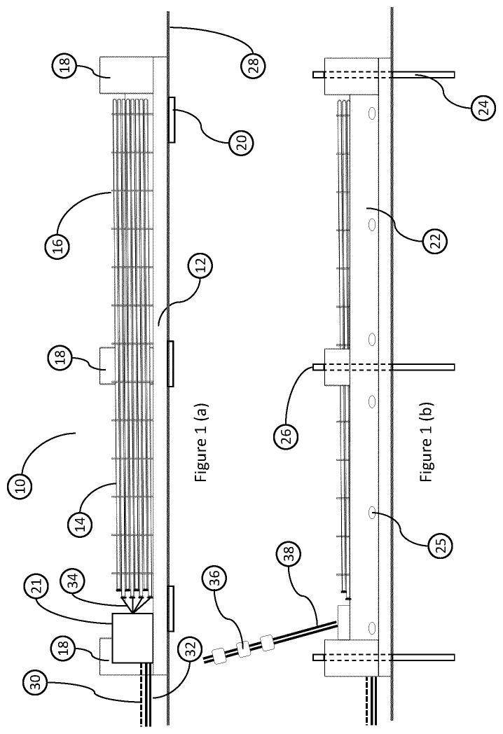

FIG. 1 is an underwater gas storage structure in cross section (a) and side view (b);

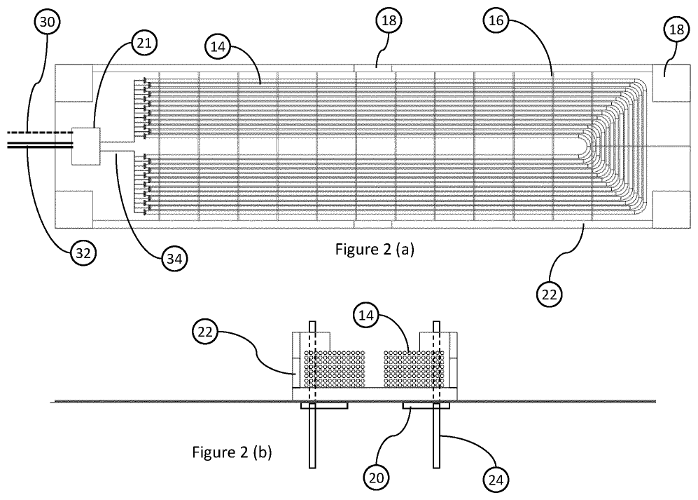

FIG. 2 is an underwater gas storage structure in plan view section (a) and end view (b);

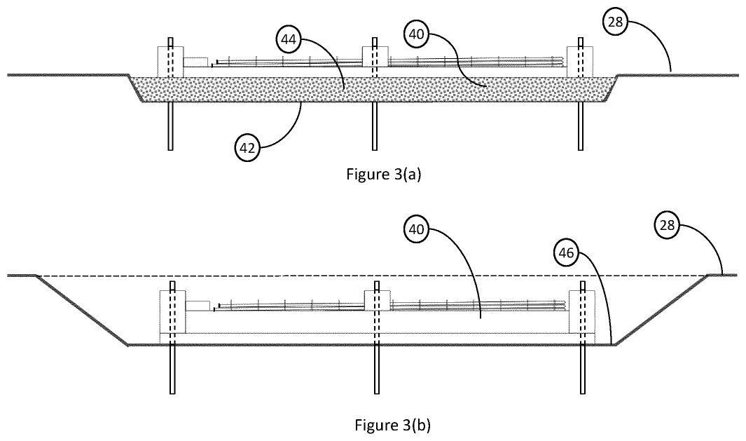

FIG. 3 is an underwater gas storage structure in side view partially buried into an excavated seabed with backfill (a) and in side view within a glory hole below mean seabed level (b);

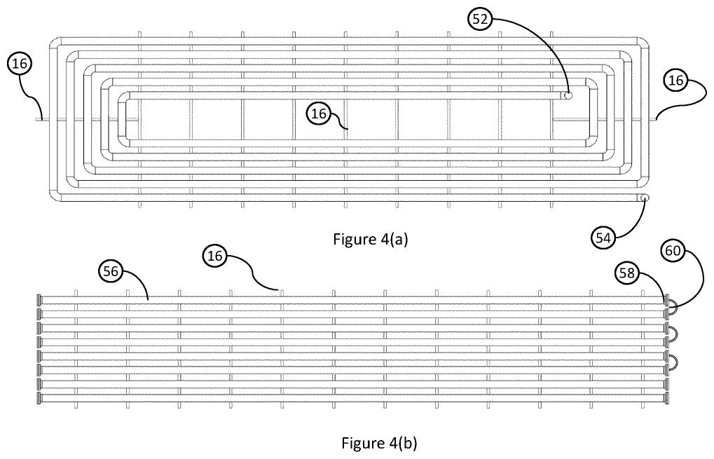

FIG. 4 is a plan view of the possible layout of the storage pipes in a continuous loop (a) and as straight section (b);

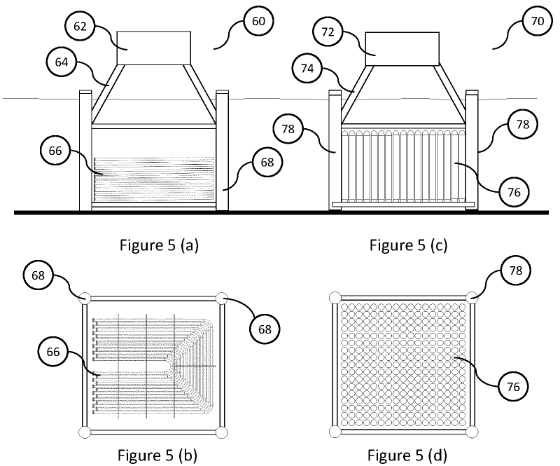

FIGS. 5(a)-(d) is embodiments of an underwater gas storage structure with a section above the water surface to provide navigation warning in side view (a),(c) and plan view (b),(d);

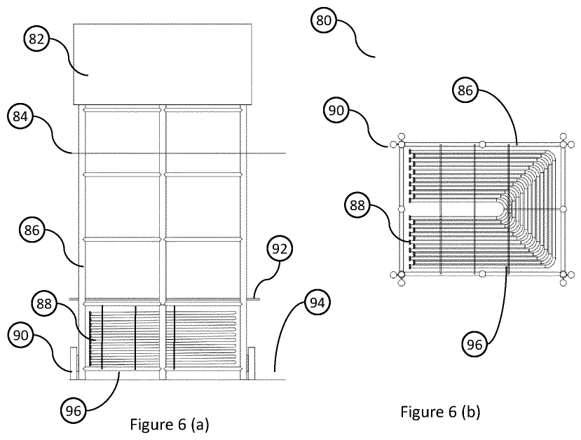

FIG. 6 is an embodiment of an underwater gas storage structure with a jacket structure in side view (a) and plan view (b);

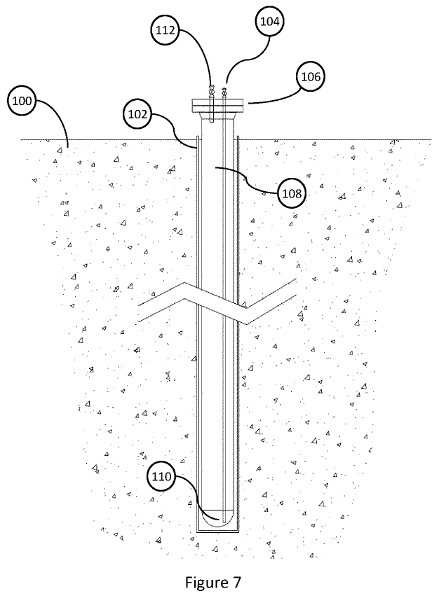

FIG. 7 is an underwater vertical gas storage structure in cross section within a drilled hole in the seabed;

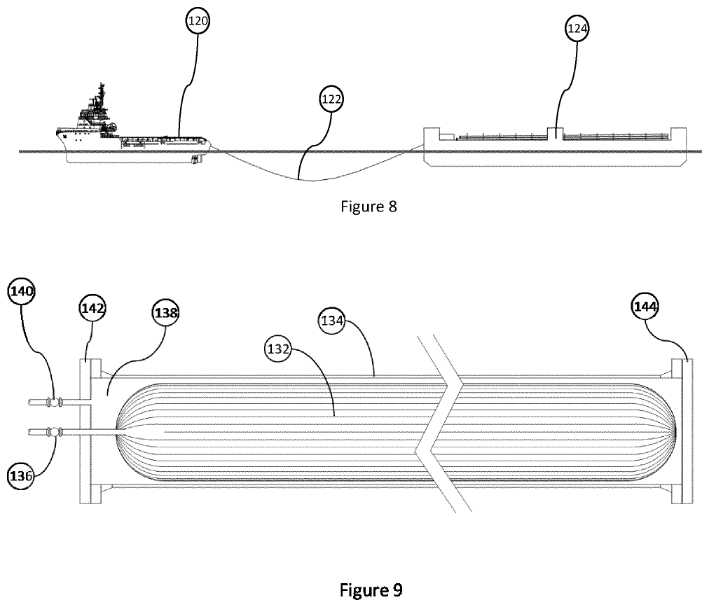

FIG. 8 is the underwater gas storage structure under tow using a towing vessel; and

FIG. 9 is a cross section view of a storage pipe with an internal storage cylinder of high strength material.

Reference is initially made to FIG. 1(a) of the drawings which illustrates a subsea storage tank, generally indicated by reference numeral 10, as a floating structure comprising an array of pipe stalks or pipe members 14, a framework 16 to hold the pipe sections 14 in the array, a hull 12 to support the array 14 and a ballasting capacity 18 in the form of towers, according to an embodiment of the present invention.

FIG. 1(a) shows a cross-section through a typical floating structure as it is resting in position on the seabed 28. The main part of the hull 12, supports the rest of the equipment above. The pipe stalks 14 are arranged longitudinally on the deck to maximise their length and are secured in position at intervals by supports 16 which must also allow the stalks 14 to expand when pressurised.

The barge can be alongside a quay or in dry-dock to allow the construction of the stalks together with the appropriate physical supports, valving and isolations to match the functional requirements.

The descent to the seabed is controlled by the towers 18 which adjust the buoyancy of the structure, especially when the pipe stalks are submerged, to keep the structure level. The descent is controlled by taking on small quantities of ballast in the towers and hull 12, ensuring the centre of gravity is well below the centre of buoyancy and using a mooring system to control the descent. Such a mooring system is described in WO2017168144, the contents of which are incorporated herein by reference.

The structure is anchored in position on the seabed by skirts or suctions anchors 20. The stalks are connected via jumpers 34 to a distribution module 21, which through valving controls the pressurisation and depressurisation of the stalks from a production facility or to a transportation vessel. The flowline or pipeline 32 between the various other facilities in the field together with the power and controls function umbilical 30 exit the structure.

The FIG. 1(b) shows the side elevation of the same structure showing the bulwarks 22 along the side of the structure, which gives the arrangement additional rigidity and strength. During deployment and recovery there are holes in the bulwark 25 which are standard mooring chocks, which allow water to freely pass onto the main deck during submergence and drain during recovery. The bulkwarks may optionally extend up above the top level of the pipe stalks to give additional protection.

This figure shows the structure anchored by piles 24, which are lowered through the tower; however any point on the structure can be chosen as an anchoring point, including on the outside of the structure. The piles are shown sticking up and hence do not need to be cut post installation.

An alternative route for contents to flow and power/controls to exit or entry the structure is via a dynamic riser 38, which is shown with distributed buoyancy modules 36. This typically would rise up to a floating vessel and the structure provides a base for such riser systems.

FIG. 2(a) shows the structure in plan view, showing the pipe stalks 14, in this case arranged in a U shaped configuration, with additional pipework providing the ‘U’ to join pipe members 14, the supports 16, including a longitudinal support on the right hand side, towers 18, distribution module or manifold 21 and bulwarks 22.

The passage of contents, power and controls is shown in the pipeline 32 and umbilical 30. The passage of fluids from the distribution module or manifold to the pipe members is managed by jumpers 34, which also may have valves to control the distribution and allow isolation of each pipe member.

FIG. 2(b) shows an end view in cross-section of the structure, showing the array arrangement of pipe stalks 14 and bulwark 22. The array is three dimensional but may be two dimensional, though this would provide significantly less storage space. In this embodiment both suction anchors 20 and piles 24 are shown.

The pipe stalks 14 are made up of pipe sections which are internally coated and welded together. Typically for pressures in the region of 150-250 barg (1 barg=100 kPa above atmospheric pressure) pipes with outside diameters in the region of 30″ to 40″ have a wall thickness and steel grade which is commonly available. Pipes offer a well proven and simple to build option with the key advantage that the fabrication into long stalks up to and in excess of 100 m can be performed onshore at low cost. The pipes are of such a diameter that they can easily be internally coated, including the welded joint and inspected. The pipe internal coating integrity is a key aspect to protect against the risks of internal and external corrosion. By using a structure composed of preferably standard line pipe sizes, welded together and coated using standard industry and well established practises, manufacture and costs are simplified. The pipes are welded together to form ‘stalks’ or pipe members which should be as long as possible in order to minimise the number of valves, flanges and connections.

FIG. 3(a) shows the structure 44, tank 10, lowered into a man-made excavation 42 in the seabed 28. This provides greater protection from wave and currents and has backfill material 40 in the void spaces between the structure and the side of the excavation. The backfill may be deployed by a vessel and/or be natural backfill.

FIG. 3(b) show the structure 40 fully contained within a ‘glory hole’ 46. This is typically used in iceberg prone areas such as Newfoundland.

FIG. 4(a) shows a plan view of an array of stalks in a continuous horizontal loop with supports 16. The end of the loops 52 and 54 consist of bends in the vertical orientation to potentially connected to an identical loop on the next layer. Such a loop can be pigged providing suitable bend radii are specified. Alternatively, the ends can be connected to a pig launcher and receiver to allow inspection of the pipe internals using standard techniques and equipment employed in the pipeline industry.

FIG. 4(b) shows a plan view of an array of stalks in their simplest configuration of straight sections 56 with flanges 58 at each end with underlying support 16. Connectivity between each of the straight sections can be provided with a hose or smaller bore pipework 60 between each stalk.

FIG. 5(a) shows a side view of an offshore structure which has an array of stalks 66 in the base of the jacket structure 64, 68. A topsides 62 is provided on the structure and buoyancy is provided for the structure by virtue of large diameter legs 68, to enable the structure to float to site and be lowered in a controlled manner by flooding of the legs.

FIG. 5(b) shows a plan view in cross section of the structure in FIG. 5(a) showing the array of stalks.

FIG. 5(c) shows a side view of an offshore structure which has an array of stalks 76 arranged in a vertical orientation, in the base of the jacket structure 74, 78. A topsides 72 is provided on the structure and buoyancy is provided for the structure by virtue of large diameter legs 78, to enable the structure to float to site and be lowered in a controlled manner by flooding of the legs.

FIG. 5(d) shows a plan view in cross section of the structure in FIG. 5(c) showing the array of stalks.

FIG. 6(a) shows a side view of an offshore structure 80, which has a topsides 82 jacket structure 86 and array of stalks 88 in the lower section, resting on a base 96. The array of stalks has a dropped impact protection structure 92 above the array of stalks. The structure is affixed to the seabed 94, through piles 90.

FIG. 6(b) shows a plan view in cross section of the arrangement of the array of stalks 88 of FIG. 6(a), together with the stalk supports 96. The surrounding jacket structure 86 is shown together with the pile guides 90.

FIG. 7 shows a cross section of a vertical stalk 108. The stalk is lowered into a pre-drilled casing 102 in the seabed 100. The stalk has a sealed bottom end 110 and two ports at the top end to allow venting 112 and draining 104 on a blind flange 106. The drain line is small bore tubing to remove any liquids within the stalk.

FIG. 8 shown an elevation of the underwater gas storage structure 124 under tow by a tug or anchor handling vessel 120, using a two line. Equally there may be a trailing tug to control the structure. Such arrangement is typical of the methodology employed to tow structures, barges and vessel in the ocean and illustrates its applicability for the invention.

FIG. 9 shows a cross section view of a typical pipe member 134, which is a straight section with no bends, in which an internal storage cylinder 132 of high strength material, for example carbon fibre, is inserted. The pipe member is shown here with a blind flange 144 on end and a blind flange with two ports 142. The fluids are supplied via a port and valve 136 directly into the internal cylinder. The void space 138 between the cylinder and the pipe member is held under a pressure to minimise the stresses on the pipe member and the cylinder, by acting to counteract the internal pressure within the cylinder. This void space pressure can be controlled by the pressure regulator valve 140, which acts as a monitoring valve in the event of a slow leakage from the internal cylinder and a pressure relief valve in the event of a more rapid leak or rupture of the cylinder. The valve 140 leads to pipework to manage the release as part of the overall subsea storage tank arrangement.

By this means the system becomes re-usable, largely self-installing and uses well established pipeline maintenance and inspection techniques to provide a reliable large buffer storage of gas offshore. Onshore inspection of the whole arrangement is also possible to inspect the internal coating and facilitate repairs as required.

In use, the pipe members/stalks will be arranged on a floating structure which can be towed out to location and sunk in a controlled manner onto or into the seabed, where it can be fixed in position for the operation duration. At the end of the operational duration the arrangement can be de-ballasted and re-floated to the surface for tow to a location where it can be inspected, cleaned and made ready for the next deployment. The system is intrinsically safe, as being under the water there is no ignition source of oxygen nearby.

The system is therefore designed to be re-usable, largely self-installing and built using existing proven fabrication methods, combining pipeline technology with submersible barge technology to facilitate the use of specialist coating to address the technical challenges of hydrogen and carbon dioxide storage.

The installation and recovery will follow the principals of prior art WO2017168144 to control the heading and position on the seabed by using a number of pre-installed mooring lines which will be connected to the structure prior to submergence to accurately locate on the desired position on the seabed. As stated there may be parts of the structure which do not fully submerge but these perform a secondary role to the storage system.

The floating structure when on the seabed can also act as a host for a variety of other functions, such as containing additional liquids or gases, acting as a manifold, act as a base for static flowline connections and/or dynamic riser, sub-sea isolation valve, etc.

The gas is generally stored under pressure the pressure dictated by the types of gas and a compromise between the storage volume achievable vs the economics. While hydrocarbons both as pressurised gas and liquids i.e. oil can be stored, the tank can also be used to store hydrogen, ammonia or any other compound with an industrial use.

By having control of pressure, the storage tank can be used for offloading stored fluids to a transportation vessel via exchange of fluids to maintain the gas under the same pressure when moving from the tank to the transportation vessel.

When deployed, the pipe stalks should preferably be arranged to minimise the number of horizontal sections where liquids could pool, plus there should be drains at the low points of the pipes and vents at the high points of each stalk. Indeed, while the figures illustrate stalks arranged in horizontal and vertical orientations, the pipe stalks may be arranged at an angle to the seabed.

The stalks may be connected together to form a larger loop comprising bends. These bend preferably should be sizes to allow ‘pigging’ of the storage system at intervals to condition, inspect and as required clean the internals.

The structure can be anchored by any of the anchoring methods used subsea, such as suction anchors, driven or drilled piles, ballast weight or even mooring lines which are anticipated to be used to control the descent of the structure onto the seabed.

The stalks may also be lowered into pre-drilled holes in the seabed, such holes being made by standard offshore drilling equipment. This gives the advantage that the stalk length is only limited by the length which can be upended to lower into the hole or increased further by provision of a pipe fabrication system on-board the drilling vessel to assembly more sections together. In this way the lengths of the stalks is only limited by the practical depth to drill down and consideration of the geology of the area in the stability of the underlying substrate. The stalk may also be cemented in-place to provide additional stability.

This invention therefore provides apparatus and a method of maximising the length of an internally coated mobile and re-useable pipeline without the length restriction on onshore fabrication or high cost of fabrication offshore. By arranging the pipe joints in an interconnected array of pipes they can be welded onshore and a single long length which is still transportable as a single unit within a ballast-able sea-going barge or vessel or as part of another submergible subsea structure. The invention by its nature also allows full internal coating of the array pipes to minimise or prevent corrosion including the use of more exotic lining materials, not normally considered for offshore use due to the time to apply and strain applied during traditional installation. Further the structure being re-deployable can be fully inspected alongside a quayside and repaired or modified as required for subsequent deployments. It can also be inspected offshore, since by provision of a pig launcher at one end and a pig receiver at the other end the pipe array can be inspected and/or cleaned/flushed in the same procedure as for a long offshore pipeline.

The array pipes generally should not be used as the means of installation of the arrangement, since the flooding of the array pipes with seawater bring about serious issues of corrosion, cleanliness and dryness which if not managed can lead to hydrate formation and accelerated corrosion. Thus the system uses a separate ballasting system, leaving the array pipes core functionality as being the fluids, notably gas, storage. To allow cleaning and internal inspection of the array pipes the interconnectivity with large diameter bends allows the passage of cleaning/inspection systems such as “pigs”. Furthermore, for large diameter pipe arrays internal inspection and repairs by human or robotic intervention is possible.

The integration of readily available pipe sections into a long continuous loop within a submersible structure which complies with maritime regulations for a towed vessel or barge provides an advantageous storage arrangement.

The principal advantage of the present invention is that it provides an underwater or subsea storage tank for the storage of gas products under pressure or oil products.

A further advantage of at least one embodiment of the the present invention is that it provides an underwater or subsea storage tank using standard line pipe and allowing more advanced welding and/or coating techniques.

A yet further advantage of the present invention is that it provides an underwater or subsea storage tank which is re-useable, unlike a laid pipeline.

A still further advantage of at least one embodiment of the present invention is that it provides an underwater or subsea storage tank which can be used as a host-subsea structure for other applications such as a manifold, riser base, tie-in point or SSIV (subsea safety isolation valve module).

1. A portable subsea storage tank for the storage of gas products under pressure or oil products comprising:
an array of pipe members, the pipe members connected together and configured to contain a fluid for storage;
a framework to hold the pipe members in the array;
a hull supporting the framework and providing transportation of the storage tank to and from a quayside to a location on the seabed and subsequent re-use at different locations;
ballast capacity to control the descent/ascent of the storage tank; and
an anchoring arrangement to hold the storage tank in position to the seabed.

2. The portable subsea storage tank according to claim 1 wherein the pipe members are formed from a plurality of pipe sections which are connected by at least one pipe bend of minimum 60°.

3. The portable subsea storage tank according to claim 2 wherein the plurality of pipe sections are connected together as a continuous long section comprising of multiple turns to form a total length of at least double that of a length of the storage tank.

4. The portable subsea storage tank according to claim 2 wherein the plurality of pipe sections are connected one to another with a conduit, the conduit having a smaller diameter than the pipe sections.

5. The portable subsea storage tank according to claim 1 wherein the framework includes connection means for installation of a pig launcher at a first location on the array and a pig receiver at a second location on the array to allow pipeline inspection, cleaning and flushing activities to be performed.

6. The portable subsea storage tank according to claim 2 wherein one or more of the pipe sections include separate internal storage cylinders of at least one non-metallic high strength material to contain gas under high pressure.

7. The portable subsea storage tank according to claim 1 wherein the portable subsea storage tank includes a pipework manifold comprising a plurality of valves to control the distribution of the fluid through the array.

8. The portable subsea storage tank according to claim 1 wherein a plurality of dynamic risers are attached to the storage tank to allow the passage of fluids and an umbilical to provide command and control to mechanical and electrical systems on the framework.

9. The portable subsea storage tank according to claim 2 wherein the pipe sections are heavy walled pipe sections, sufficient to avoid floating in seawater when empty.

10. The A portable subsea storage tank according to claim 2 wherein the pipe sections have an outside diameter between 0.30 m to 1.5 m.

11. The portable subsea storage tank according to claim 10 wherein the pipe sections have an outside diameter between 30″ to 40″ (0.762 m to 1.016 m).

12. The portable subsea storage tank according to claim 1 wherein the array is 10 m to 250 m in length along parallel arranged pipe members.

13. The portable subsea storage tank according to claim 1 wherein the pipe members are arranged side by side and on top of each other to provide a three dimensional array.

14. (canceled)

15. (canceled)

16. (canceled)

17. (canceled)

18. (canceled)

19. The portable subsea storage tank according to claim 1 wherein the anchoring arrangement is selected from a group comprising: suction anchors, driven piles, drilled piles, ballast weight and mooring lines.

20. A method of self-installing a portable subsea storage tank comprising the steps of:
(a) providing a portable subsea storage tank comprising:
an array of pipe members, the pipe members connected together and configured to contain a fluid for storage;
a framework to hold the pipe members in the array;
a hull supporting the framework and providing transportation of the storage tank to and from a quayside to a location on the seabed and subsequent re-use at different locations;
ballast capacity to control the descent/ascent of the storage tank; and
an anchoring arrangement to hold the storage tank in position to the seabed;
(b) floating and towing the portable subsea storage tank to a desired location;
(c) adjusting ballast capacity on the subsea storage tank to thereby submerge the subsea storage tank;
(d) anchor the subsea storage tank to the seabed; and
(e) introducing a fluid into the pipe members of the subsea storage tank to store the fluid.

21. (canceled)

22. The method of self-installing a portable subsea storage tank according to claim 20 wherein the method includes the steps of adjusting the ballast capacity to re-float the storage tank and towing the storage tank to a further location.

23. The method of self-installing a portable subsea storage tank according to claim 20 wherein the method includes the step of inspecting the pipe members by using a pipeline pig.

24. The method of self-installing a portable subsea storage tank according to claim 20 wherein the gas is hydrogen under pressure produced from renewable sources.

25. The method of self-installing a portable subsea storage tank according to claim 20 wherein the gas is carbon dioxide under pressure and the method includes the step of injecting the gas into sub-surface reservoirs.

26. The method of self-installing a portable subsea storage tank according to claim 20 wherein the method includes the step of offloading stored fluids to a transportation vessel via exchange of fluids to maintain the gas under the same pressure when moving from the tank to the transportation vessel.
